(19) United States
(12) Patent Application Publication
(10) Pub. No.: US 2014/0370472 A1
(43) Pub. Date: Dec. 18, 2014

(54) METHODS AND SYSTEMS FOR PROVIDING VALUE ASSESSMENTS

(71) Applicant: Robert KAISER, Vancouver (CA)

(72) Inventor: Robert KAISER, Vancouver (CA)

(21) Appl. No.: 14/154,836

(22) Filed: Jan. 14, 2014

Related U.S. Application Data
(60) Provisional application No. 61/835,087, filed on Jun. 14, 2013.

(51) Int. Cl. G09B 7/02

(52) U.S. Cl. CPC G09B 7/02
USPC 434/236

(57) ABSTRACT

Systems, methods, and computer interfaces for providing value assessment for a user that may involve interconnected computer hardware configured in a particular manner for receiving or suggesting a plurality of life aspects; receiving evaluation input data for each of a plurality of life aspects, wherein the evaluation input data indicates a level of satisfaction for the respective life aspect; receiving or suggesting a plurality of negative triggers; for each of the plurality of negative triggers, receiving or suggesting a positive counter to the respective negative trigger; identifying a plurality of values based on the positive counters to the plurality of negative triggers; for each combination of a value of the plurality of values and a life aspect of the plurality of life aspects, receiving value assessment input data that indicates how present the respective value is within the respective life aspect; and generating value assessment results based on the received value assessment input data and the evaluation input data.

### FIELD

The embodiments described herein relate to the field of processing and transforming data related to value assessments, personal growth, life style and/or personal characteristics. In particular, the embodiments relate to collecting and transforming data regarding life aspects and values to allow a user to assess his or her own well-being and identify and monitor important life values.

### INTRODUCTION

As a person participates in society, he or she plays various roles (e.g., employee, manager, parent, spouse or mentor) and is physically and emotionally affected by many different aspects of life, such as work, relationship, family, and finance, for example. A person's well-being and overall satisfaction with life may be tied to multiple personal, cultural or ethnical values in a personal value system. Such values inherently guide people's behaviors and actions in providing a broad preference as to what is important, good, appropriate or otherwise beneficial to one or more life aspects. Understanding how the values interrelate with various life aspects may lead to greater awareness of one's own well-being and may improve satisfaction with life in general. In addition, if a person can monitor how his or her value system and satisfaction with life progress over time, he or she can then take appropriate actions to achieve greater personal happiness. Corporations and organizations may encourage employees to evaluate their professional satisfaction and values. There exists a need for improved systems and methods for value assessment, or at least alternatives.

### SUMMARY

In a first aspect, embodiments described herein may provide a computer device for providing value assessments for a user, wherein the device comprises an electronic receiver coupled to a life assessment module for receiving or suggesting a plurality of life aspects, wherein each life aspect categorizes an area of the user's life, and for receiving evaluation input data for each of a plurality of life aspects, wherein the evaluation input data indicates a level of satisfaction for the respective life aspect; a trigger module for receiving or suggesting a plurality of negative triggers, wherein each negative trigger may create negative reaction for the user; and a counter module for, for each of the plurality of negative triggers, receiving or suggesting a positive counter to the respective negative trigger, wherein each positive counter may counteract the negative reaction of the negative trigger; a processor configured to generate: a value module for identifying a plurality of values based on the positive counters to the plurality of negative triggers, wherein each value is a belief that influences an attitude or a behaviour of the user, and for, for each combination of a value of the plurality of values and a life aspect of the plurality of life aspects, receiving value assessment input data that indicates how present the respective value is within the respective life aspect; and a comparison module for transforming the received value assessment input data into value assessment results; a data storage device for persistently storing the plurality of life aspects, the plurality of negative triggers, the plurality of positive counters, the plurality of values; and a transmitter for electronically transmitting the value assessment results to a client device coupled thereto via a network.

In another aspect, embodiments described herein may provide a computer implemented method for providing value assessments for a user, wherein the computer comprises a processor and a memory coupled to the processor and configured to store instructions executable by the processor to perform the method comprising: receiving or suggesting a plurality of life aspects, wherein each life aspect categorizes an area of the user's life; receiving evaluation input data for each of a plurality of life aspects, wherein the evaluation input data indicates a level of satisfaction for the respective life aspect; receiving or suggesting a plurality of negative triggers, wherein each negative trigger may create negative reaction for the user; for each of the plurality of negative triggers, receiving or suggesting a positive counter to the respective negative trigger, wherein each positive counter may counteract the negative reaction of the negative trigger; identifying a plurality of values based on the positive counters to the plurality of negative triggers, wherein each value is a belief that influences an attitude or a behavior of the user; for each combination of a value of the plurality of values and a life aspect of the plurality of life aspects, receiving value assessment input data that indicates how present the respective value is within the respective life aspect; and generating value assessment results based on the received value assessment input data.

In accordance with some embodiments, the method may further comprise, for each of the plurality of values, generating a total value present score using the received value assessment input data for the respective value, wherein the total value score indicates how present the respective value is within the plurality of life aspects.

In accordance with some embodiments, the method may further comprise, for each of the plurality of life aspects, generating a total life alignment score using the received value assessment input data for the respective value, wherein the total life alignment score indicates how present the plurality of values is within the respective life aspect.

In accordance with some embodiments, the method may further comprise generating life aspect comparison results for each of the plurality of life aspects, wherein the life aspect comparison results compare, for each of the plurality of life aspects, the evaluation input data and the total life alignment score for the respective life aspect.

In accordance with some embodiments, the value assessment input data may be received for a first time interval, and wherein the method may further comprise: receiving additional value assessment input data for a second time interval; and benchmarking the additional value assessment input data for the second time interval against the value assessment input data for the first time interval.

In accordance with some embodiments, the method may further comprise, for each of the plurality of values: generating a first total value present score for the first time interval using the received value assessment input data for the first time interval for the respective value, wherein the first total value score indicates how present the respective value is within each of the plurality of life aspects; generating at least a second total value present score for the second time interval using the received value assessment input data for the second time interval for the respective value, wherein the second total value score indicates how present the respective value is within each of the plurality of life aspects; and benchmarking the second total value present score against the first total value present score.

In accordance with some embodiments, the method may further comprise, for each of the plurality of life aspects: generating a first total life alignment score using the received value assessment input data for the first time interval for the respective value, wherein the total life alignment score indicates how present the plurality of values is within the respective life aspect; generating a second total life alignment score using the received value assessment input data for the second time interval for the respective value, wherein the total life alignment score indicates how present the plurality of values is within the respective life aspect; and benchmarking the second total life alignment score against the first total life alignment score.

In accordance with some embodiments, the value assessment input data and evaluation input data are received for a first time interval, and the method may further comprise: receiving additional value assessment input data for a second time interval; receiving additional evaluation input data for a second time interval; benchmarking the additional value assessment input data for the second time interval against the value assessment input data for the first time interval; and benchmarking the additional evaluation input data for the second time interval against the evaluation input data for the first time interval.

In accordance with some embodiments, the plurality of life aspects may comprise one or more members of the group selected from personal happiness, career, health, significant other, friendships, family, recreation, and finance.

In accordance with some embodiments, the plurality of values may be selected from the group consisting of faith, hard work, integrity, love, and self.

In accordance with some embodiments, the value assessment results are generated based on the received evaluation input data.

In another aspect, there is provided a system for providing value assessments for a user, wherein the system comprises a processor and a memory coupled to the processor and configured to store instructions executable by the processor to provide: a value assessment module for receiving or suggesting a plurality of life aspects, wherein each life aspect categorizes an area of the user's life, and for receiving evaluation input data for each of a plurality of life aspects, wherein the evaluation input data indicates a level of satisfaction for the respective life aspect; a trigger module for receiving or suggesting a plurality of negative triggers, wherein each negative trigger may create negative reaction for the user; a counter module for each of the plurality of negative triggers, receiving or suggesting a positive counter to the respective negative trigger, wherein each positive counter may counteract the negative reaction of the negative trigger; a value module for identifying a plurality of values based on the positive counters to the plurality of negative triggers, wherein each value is a belief that influences an attitude or a behaviour of the user, and for each combination of a value of the plurality of values and a life aspect of the plurality of life aspects, receiving value assessment input data that indicates how present the respective value is within the respective life aspect; and a comparison module for generating value assessment results based on the received value assessment input data.

In a further aspect, there is provided a computer interface for providing value assessments for a user, wherein the computer interface is provided using a processor and a memory coupled to the processor and configured to store instructions executable by the processor to: receive a plurality of life aspects, wherein each life aspect categorizes an area of the user's life; receive evaluation input data for each of a plurality of life aspects, wherein the evaluation input data indicates a level of satisfaction for the respective life aspect; receive a plurality of negative triggers, wherein each negative trigger may create negative reaction for the user; for each of the plurality of negative triggers, receive a positive counter to the respective negative trigger, wherein each positive counter may counteract the negative reaction of the negative trigger; identify a plurality of values based on the positive counters to the plurality of negative triggers, wherein each value is a belief that influences an attitude or a behavior of the user; for each combination of a value of the plurality of values and a life aspect of the plurality of life aspects, receive value assessment input data that indicates how present the respective value is within the respective life aspect; and update a display coupled to the processor to provide value assessment results based on the received value assessment input data.

In accordance with some embodiments, the processor may be further configured to, for each of the plurality of values, update the display to provide a total value present score calculated using the received value assessment input data for the respective value, wherein the total value score indicates how present the respective value is within the plurality of life aspects.

In accordance with some embodiments, the processor may be further configured to, for each of the plurality of life aspects, update the display to provide a total life alignment score calculated using the received value assessment input data for the respective value, wherein the total life alignment score indicates how present the plurality of values is within the respective life aspect.

In accordance with some embodiments, the processor may be further configured to, update the display to provide life aspect comparison results for each of the plurality of life aspects, wherein the life aspect comparison results compare, for each of the plurality of life aspects, the evaluation input data and the total life alignment score for the respective life aspect.

In accordance with some embodiments, the value assessment input data is received for a first time interval, and wherein the processor may be further configured to: receive additional value assessment input data for a second time interval; and update the display to provide a benchmark of the additional value assessment input data for the second time interval against the value assessment input data for the first time interval.

In accordance with some embodiments, the processor may be further configured to, for each of the plurality of values: generate a first total value present score for the first time interval using the received value assessment input data for the first time interval for the respective value, wherein the first total value score indicates how present the respective value is within each of the plurality of life aspects; generate at least a second total value present score for the second time interval using the received value assessment input data for the second time interval for the respective value, wherein the second total value score indicates how present the respective value is within each of the plurality of life aspects; and update the display to provide a benchmark the second total value present score against the first total value present score.

In accordance with some embodiments, the processor may be further configured to, for each of the plurality of life aspects: generate a first total life alignment score using the received value assessment input data for the first time interval for the respective value, wherein the total life alignment score indicates how present the plurality of values is within the respective life aspect; generate a second total life alignment score using the received value assessment input data for the second time interval for the respective value, wherein the total life alignment score indicates how present the plurality of values is within the respective life aspect; and update the display to benchmark the second total life alignment score against the first total life alignment score.

In accordance with some embodiments, the value assessment input data and evaluation input data are received for a first time interval, and where the processor may be further configured to: receive additional value assessment input data for a second time interval; receive additional evaluation input data for a second time interval; update the display to benchmark the additional value assessment input data for the second time interval against the value assessment input data for the first time interval; and update the display to benchmark the additional evaluation input data for the second time interval against the evaluation input data for the first time interval.

In accordance with some embodiments, the value assessment results may be generated based on the received evaluation input data.

Other aspects and features will become apparent, to those ordinarily skilled in the art, upon review of the following description of some exemplary embodiments.

### DRAWINGS

FIG. 1 is a block diagram of a system for collecting and analyzing data regarding various life aspects and values according to one or more embodiments;

FIG. 2 is a block diagram of a value assessment system for collecting and analyzing data regarding various life aspects and values according to one or more embodiments;

FIG. 3 is a flow chart diagram of a method for collecting and analyzing regarding various life aspects and values according to one or more embodiments;

FIG. 4 is an example of a value assessment table for a user according to one or more embodiments;

FIGS. 5A and 5B are examples of other value assessment tables for a user according to one or more embodiments;

FIG. 6 is an example of value assessment results according to one or more embodiments;

FIG. 7 is an example of other value assessment results according to one or more embodiments;

FIG. 8 is another example of other value assessment results according to one or more embodiments; and

FIG. 9 is an example user interface providing value assessment results accordingly to one or more embodiments.

### DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic optical, and electronic storage media, volatile memory, non-volatile memory and the like. Non-transitory computer-readable media comprise all computer-readable media, with the exception being a transitory, propagating signal. The term non-transitory is not intended to exclude computer readable media such as a volatile memory or RAM, where the data stored thereon is only temporarily stored. The computer useable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may use electronic hardware to receive and identify relevant data sets and transform the identified data into useful computing results. The computer hardware may use receivers and various input devices to receive and identify data. The computer hardware may be coupled via a network to provide an integrated computer system. Particularly configured processors may transform data in useful, new and inventive ways. The transformed data may be transmitted using a transmitter to other computer devices, or used to update display screens, and so on.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The embodiments described herein are implemented by physical computer hardware embodiments. The embodiments described herein provide useful physical machines and particularly configured computer hardware arrangements of computing devices, servers, computer terminals, processors, memory, networks, receivers, transmitters, input devices, output devices, for example. The embodiments described herein, for example, is directed to computer apparatuses, and methods implemented by computers through the processing of electronic data signals.

The embodiments described herein involve computing devices, servers, receivers, transmitters, processors, memory, display, networks, input devices, output devices particularly configured to implement various acts. The embodiments described herein are directed to electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, a various hardware components.

Substituting the computing devices, servers, receivers, transmitters, processors, memory, display, networks, input devices, and output devices particularly configured to implement various acts for non-physical hardware, using mental steps for example, may substantially affect the way the embodiments work.

Such computer hardware are clearly essential elements of the embodiments described herein, and they cannot be omitted or substituted for mental means without having a material effect on the operation and structure of the embodiments described herein. The computer hardware is essential to the embodiments described herein and is not merely used to perform steps expeditiously and in an efficient manner.

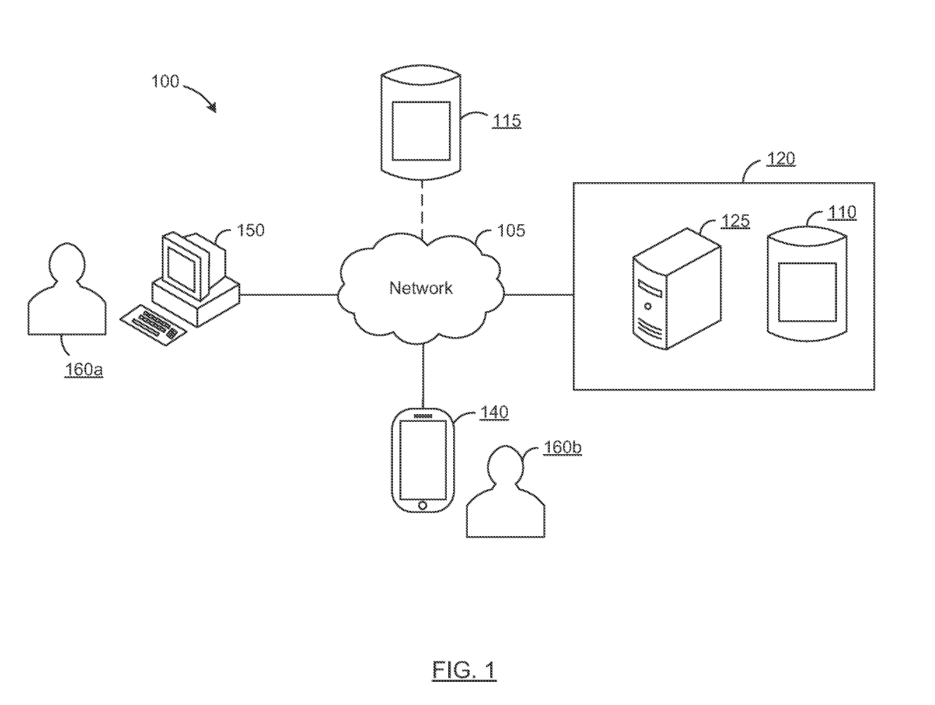

Referring now to FIG. 1 there is shown a block diagram of a system 100 (e.g. computer device, server device) for collecting and analyzing data regarding various life aspects and values to provide value assessments according to some embodiments. In this system 100, one or more users 160a, 160b may access the services provided by value assessment system 120 and various data storage devices 110, 115 to obtain value assessment results related to various life aspects and values. In some embodiments, the system 100 may be part of or associated with a traditional “bricks and mortar” educational or mental health institution (e.g., university, hospital, etc.), or may be an independent service provider. For example, students and instructors of an educational system may use system 100 to conduct value assessments. Further, patients of a mental health institution may use system 100 to conduct value assessments and care providers may review value assessment results with the patients. In some embodiments, the system 100 may be part of or associated with a corporation or organization where the values may relate to professional values and may be used by employees to conduct a professional value assessment and engagement.

The system 100 may include input devices (e.g. as a keyboard, mouse, camera, touch screen and a microphone), output device (e.g. display screen and a speaker), transmitters, receivers, networks, and so on.

Communication between the users 160a, 160b and the value assessment system 120 may occur either directly or indirectly using any suitable computing device 140, 150. For example, the user 160a may use a computing device such as a desktop computer 150 that has at least one input device (e.g. a keyboard and a mouse) and at least one output device (e.g. a display screen and speakers). As another example, the user 160b may use a computing device such as a mobile computing device 140 that has at least one input device (e.g. a keypad and a touch interface) and at least one output device (e.g. a display screen and speakers).

The value assessment system 120 may include a number of hardware and software components or modules for facilitating the gathering, analyzing and processing of life and value assessment data for each user. The value assessment system 120 can include one or more processing devices 125 (e.g. servers), each having one or more processors. The processing devices 125 may be coupled to receivers to receive data from other components and devices. The processing devices 125 may be configured to send information using transmitters to be displayed on one or more computing devices 140, 150 in association with the value assessment system 120. In some embodiments, a processing device 125 may be a computing device (e.g. a desktop computer or a laptop). The processing devices 125 may be configured to transform received data using control logic programming.

Value assessment system 120 may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. Value assessment system 120 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Value assessment system 120 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. Value assessment system 120 may include one or more input devices, such as a keyboard, mouse, camera, touch screen and a microphone, and may also include one or more output devices such as a display screen and a speaker. Value assessment system 120 has a network interface in order to communicate with other components, to serve a central application and other applications, and perform other computing applications by connecting to network 105 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one value assessment system 120 is shown for clarity, there may be multiple value assessment systems 120 or groups of value assessment systems 120 distributed over a wide geographic area and connected via e.g. network 105.

Value assessment system 120 may be connected to one or more computing devices 140, 150. Computing devices 140, 150 may be any suitable device for facilitating communication between the users 160a, 160b and the value assessment system 120. For example, computing device 140, 150 could be a laptop wirelessly coupled to an access point (e.g. a wireless router, a cellular communications tower, etc.), a wirelessly enabled personal data assistant (PDA) or smart phone, a terminal, or a tablet computer. Computing devices 140, 150 is operable by a user 160 and may be any portable, networked (wired or wireless) computing device including a processor and memory and suitable for facilitating communication between one or more computing applications of computing device 140, 150 (e.g. a computing application installed on or running on the computing device 140, 150) and value assessment system 120.

Computing device 140, 150 may be connected to the value assessment system 120 via any suitable communications channel. For example, the computing device 140, 150 may communicate to the value assessment system 120 over a local area network (LAN) or intranet, or using an external network (e.g. by using a browser on the computing device to browse to one or more web pages presented over the Internet over a data connection).

In accordance with some embodiments, computing device 140, 150 may be a mobile computing device, or other networked computing device including a processor and memory, such as a personal computer, workstation, server, portable computer, mobile phone, personal digital assistant, laptop, smart phone, WAP phone, or a combination of these. Computing device 140, 150 typically includes one or more input devices, such as a keyboard, mouse, camera, touch screen and a microphone, and also includes one or more output devices such as a display screen and a speaker. Computing device 140, 150 has a network interface for connecting to network 105 in order to communicate with other components. Although only two computing devices 140, 150 are illustrated in FIG. 1, there may be fewer or more computing devices 140, 150 connected to value assessment system 120 via network 105. Computing device 140, 150 may be connected to the value assessment system 120 via any suitable communications channel. For example, the computing device 140, 150 may communicate to the value assessment system 120 over a Local Area Network (LAN) or intranet, or using an external network. Computing device 140, 150 may also have additional embedded components such as a global positioning system (GPS), a clock, a calendar, and so on.

The value assessment system 120 may be connected to one or more data storage devices 110, 115 (e.g. memory, etc.) that are in communication with the processing devices 125 in the value assessment system 120. The data storage devices 110, 115 may be configured to host databases, file systems, and so on (e.g. relational SQL databases) that store input data from users 160a, 160b, historical value assessment data for users 160a, 160b, and any other types of data the value assessment system 120 generates or receives (e.g. user profile data). One or more of the data storage devices 115 may be geographically remotely located from the physical location of value assessment system 120.

In some embodiments, the value assessment system 120 may also be connected to one or more backup servers (not illustrated) that may duplicate some or all of the data stored on the data storage devices 110, 115. Such The backup servers may be desirable for disaster recovery (e.g. to prevent undesired data loss in the event of an event such as a fire, flooding, or theft).

Network 105 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although not shown, value assessment system 120, computing device 140, 150, and other components (not shown) may connect to network 105 via a firewall, which is a device, set of devices or software that inspects network traffic passing through it, and denies or permits passage based on a set of rules and other criteria. Firewall may be adapted to permit, deny, encrypt, decrypt, or proxy all computer traffic between network 105, value assessment system 120, computing device 140, 150, and other components based upon a set of rules and other criteria. For example, firewall may be a network layer firewall, an application layer firewall, a proxy server, or a firewall with network address translation functionality. Network 105 is operable to secure data transmissions using encryption and decryption.

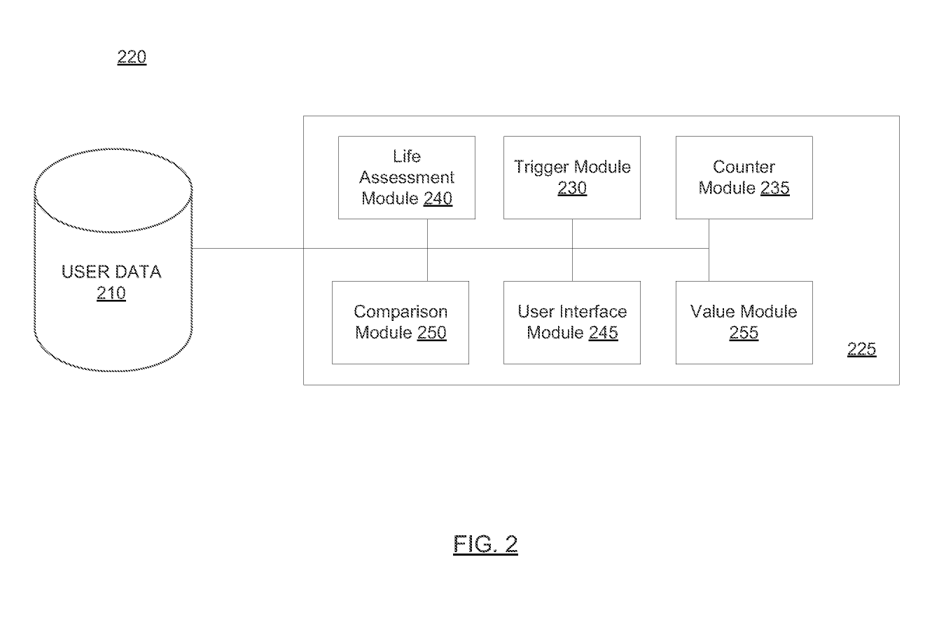

Reference is now made to FIG. 2, there is shown a block diagram of a value assessment system for collecting and analyzing data regarding various life aspects and values according to one or more embodiments. Value assessment system 220 is operable to collect input data from users 160a, 160b via computing device 140, 150, store the collected data in one or more user profiles at user data storage device 210, process the data from user data storage device 210, evaluate one or more user profiles, generate and store value assessment results (e.g. output data) for each of the one or more user profiles, and send the output to one or more users.

User data storage device 210, as previously described, can receive, store and retrieve input data from computing device 140, 150 and any other types of data the value assessment system 220 generates or receives (e.g. user profile data). User data storage device 210 may be connected to central server 225, which includes various hardware modules such as Trigger Module 230, Counter Module 235, Life Assessment Module 240, User Interface Module 245, Comparison Module 250, and Value Module 255. The modules may be computer software or hardware applications designed to help the user to perform specific functions, and may include an application plug-in, a widget, instant messaging application, mobile device application, e-mail application, online telephony application, java application, web page, or web object residing, executing, running or rendered on the value assessment system 220. There may be corresponding modules provided on computing device 140, 150.

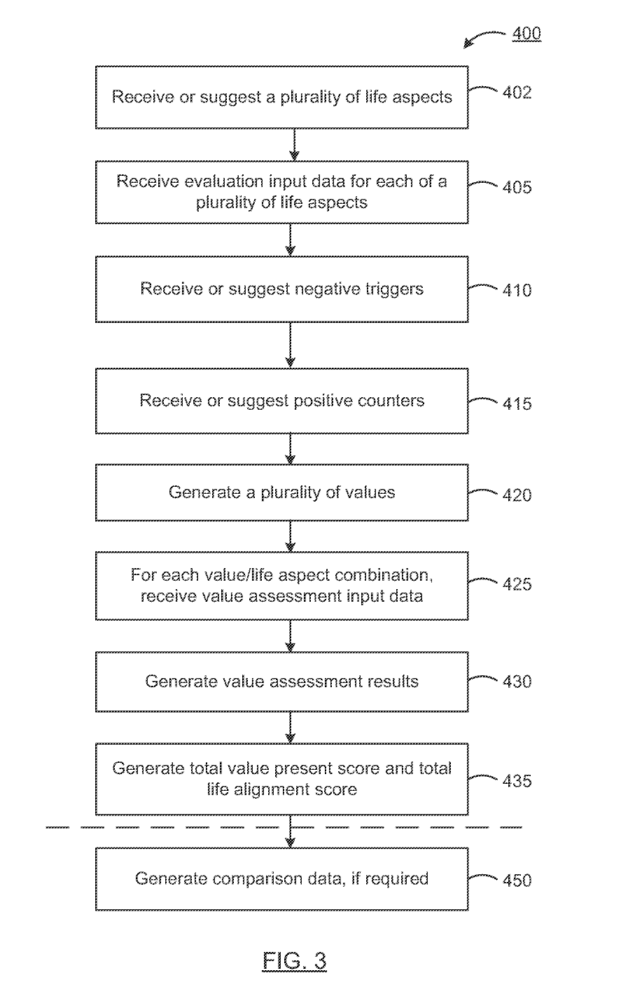

Reference will also be made to FIG. 3, which shows an exemplary flow chart diagram of a method 400 for collecting and processing data relating to life aspects and values according to one or more embodiments.

Value assessment system 220 is operable to store a user profile corresponding to each user. The user profile may be associated with a user identifier to link the user to the corresponding user profile. The user profile may store input data received from user and data processed and generated by value assessment system 220 such as value assessment results. Value assessment system 220 is operable to collect demographic data (e.g. age, gender, location, occupation, status, citizenship, religion) from user for storage in the corresponding user profile. The demographic data may be used to benchmark value assessment data and generate summary results. For example, value assessment system 220 is operable to generate a mapping interface with different cities or countries and provide value assessment results for a particular area. For example, value assessment system 220 is operable to compute the top ten values for a particular country or an average level of happiness for a particular city. Value assessment system 220 is operable to perform research to determine values and happiness for different locations. Value assessment system 220 is operable to filter value assessment data based on different demographic characteristics. Value assessment system 220 is operable to receive data from third party system to perform data analysis and benchmarking based on different demographic characteristics.

Value assessment system 220 may be used by a corporation or organization to evaluate a level of overall professional engagement (e.g. professional value assessment) for employees of the corporation or organization. In such case, the user profile (e.g. employee profile) may include additional attributes such as team, group, department, city, office, country, division, and the like. This may enable value assessment results to be reviewed by employers and employees on different levels of granularity, such as by team, division, country, and the like, to determine professional engagement by different groups of employees. Different work cultures may directly correspond to different levels of professional engagement (e.g. professional value assessment). Employers and employees may be able to detect trends and patterns based on the value assessment results.

In some embodiments, one or more of the users 160a, 160b may be required to authenticate their identities in order to communicate with the value assessment system 120, and to retrieve records relating to historical value assessments for the user 160, or historical input data for the user 160. For example, the users 160a, 160b may be required to input an identifier such as a login name and/or a password or otherwise identify themselves to gain access to the value assessment system 120 and gain access to their records.

At step 402, Life Assessment Module 240 determines or identifies life aspects for a user evaluation session. Life Assessment Module 240 may store life aspects and provide a listing of life aspects for selection by user. Life Assessment Module 240 may suggest a list of life aspects based on historical data in a user profile, demographic characteristics, or based on a general list of common life aspects stored in a local data storage device. Life aspects may be indexed in association with a user, historical data, demographics, and so on. The user 160 may also provide one or more life aspects as input data. The life aspects may include user-entered life aspects, life aspects based on historical data in a user profile and confirmed by the user, life aspects from the general list of common life aspects and chosen by the user, life aspects stored by Life Assessment Module 240, life aspects based on user demographics and confirmed by user, and so on. In the context of a corporation or organization, the life aspect may relate to professional and work related life aspects such as aspects relating to careers goals, objectives, challenges, and so on.

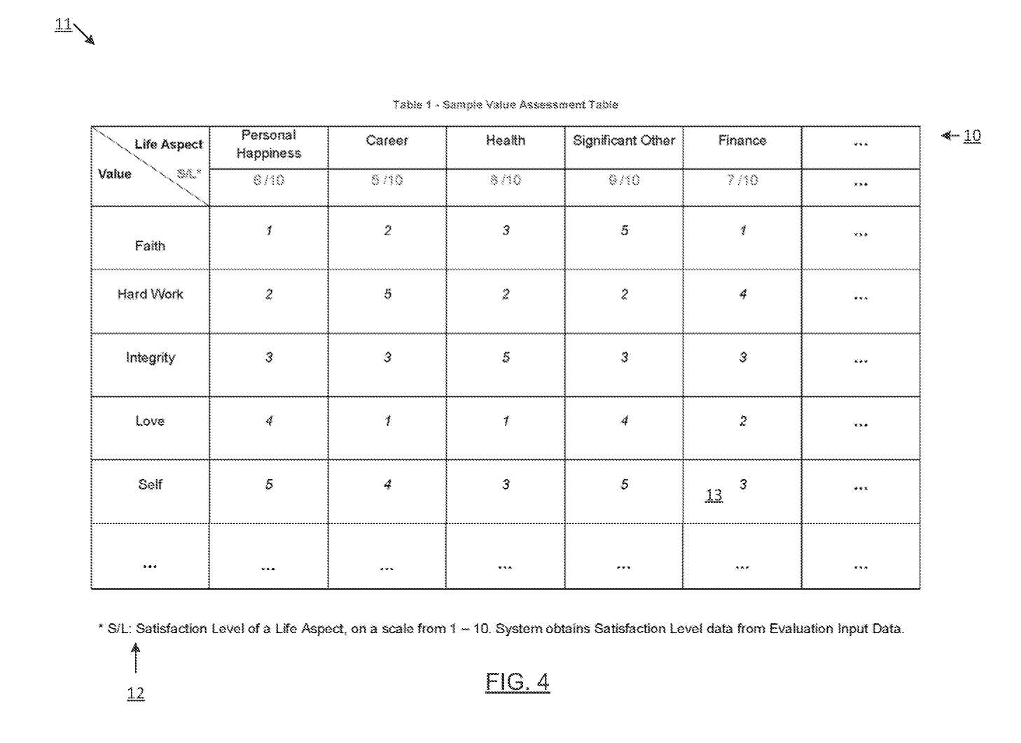

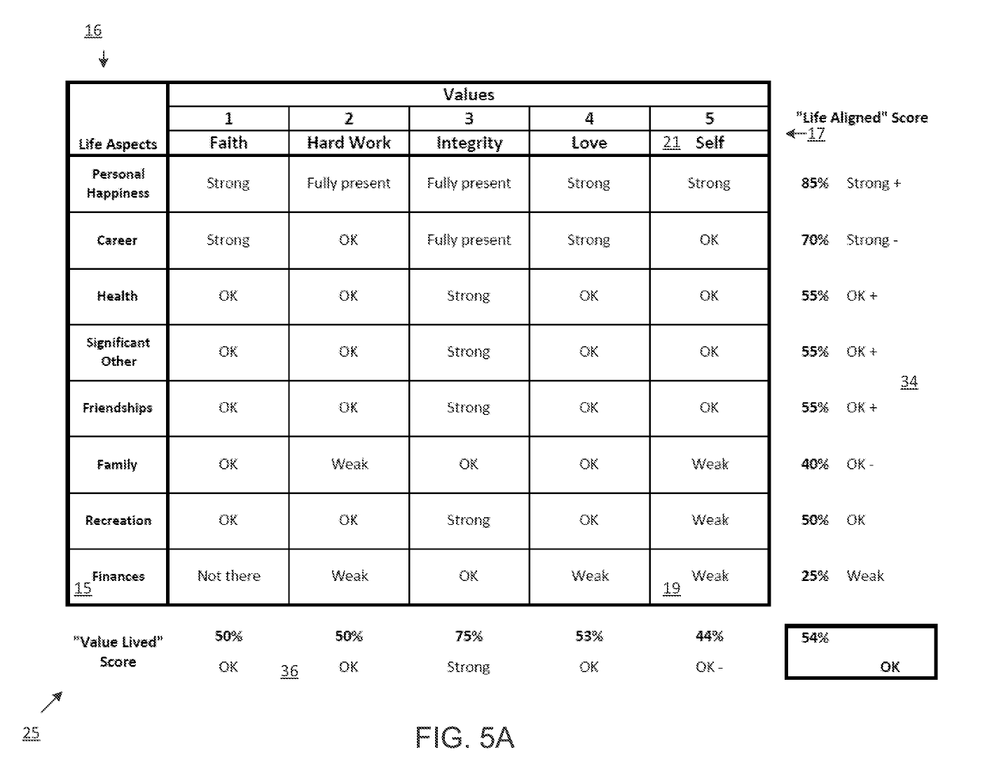

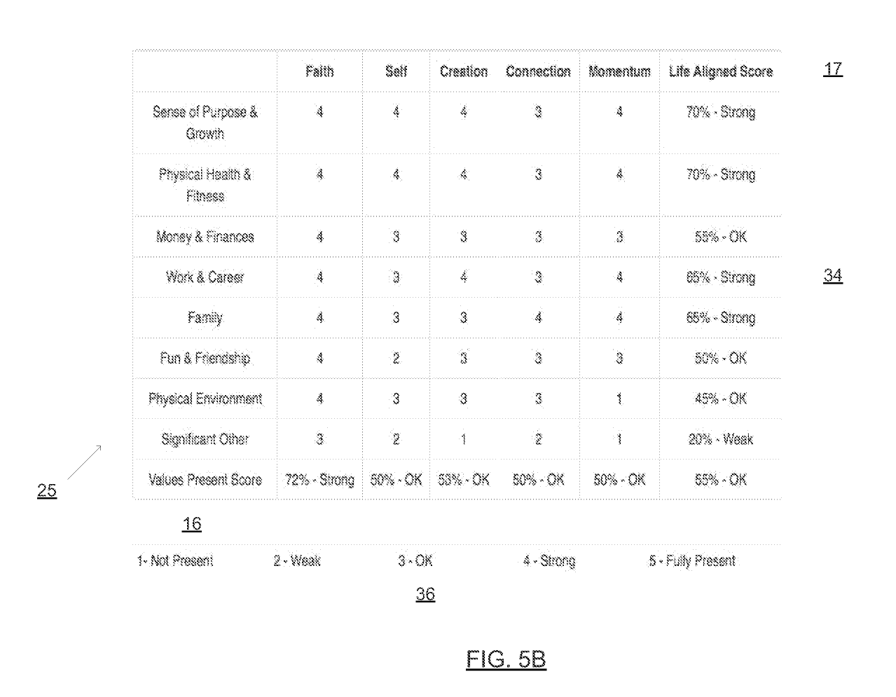

Referring now to FIGS. 4, 5A and 5B there are shown exemplary life aspects 16, 18, such as, for example, Personal Happiness, Career, Health, Significant Other, Friendships, Family, Recreation, Purpose, Growth, Physical Environment, and Finances. Further examples include self-actualization (morality, creativity, problem solving), esteem (self-esteem, confidence, achievement, respect of others, respect by others), love or belonging (friendship, family, sexual intimacy), safety (security of body, employment, resources, morality, family, health, property), physiological (breathing, food, water, sex, sleep, homeostasis, excretion). These are non-limiting examples and other life aspects may be used. A life aspect categorizes an area of the user's life. That is, a life aspect may be a category defining an area or part of a user's life. A life aspect may be specific to work, and may categorizes different areas of a user's professional life. A life aspect may also categorize an area of a user's personal life. The number of total life aspects and types of life aspects may vary across different user profiles or users. In addition, a user profile may have different life aspects associated with different user evaluation sessions and dates. For any one user profile, the number of total life aspects, as well as life aspects stored, may vary. That is, for a specific user, he or she may have different life aspects associated with a specific date and time. For example, user A's user profile may have six life aspects, while user B's profile may have two sets, one with five life aspects and the other one with eight life aspects. Life aspects may vary across different users and evaluation sessions. A user may log in and update their life aspects for their profile and evaluation sessions. Life Assessment Module 240 is operable to store a unique set of life aspects for a particular user as part of or in association with the user's profile. The set of life aspects for a user may be associated with a unique identifier for use by Life Assessment Module 240 to identify that set of data as a set of life aspects.

In accordance with some embodiments, a life aspect may be a life choice, or a category defining an area of a user's life that the user is considering making a change in. For example, a life aspect may be a career choice. One life aspect may be to stay with a current job, another life aspect may be to switch to a career in design, and a third life aspect may be to go back to school to study law. Value assessment system 120, 220 may be used to evaluate each life choice or option in order to assist the user in selecting an option. As further examples, a life aspect may be moving to a new location where another life aspect may be staying in a current location, a life aspect may be going to a particular school such as the University of Toronto wherein another life aspect may be going to another school such as Harvard University. These are non-limiting examples only and other life options or choices may be used as life aspects. Accordingly, life aspects may relate to a present area or aspect of a user's life and may also relate to a future or possible aspect of a user's life.

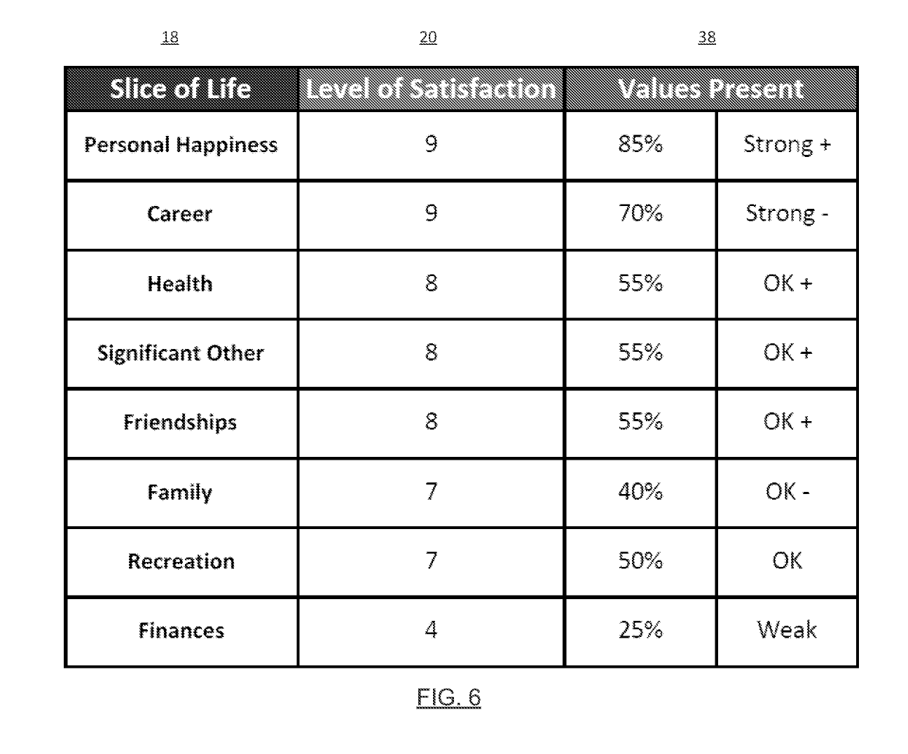

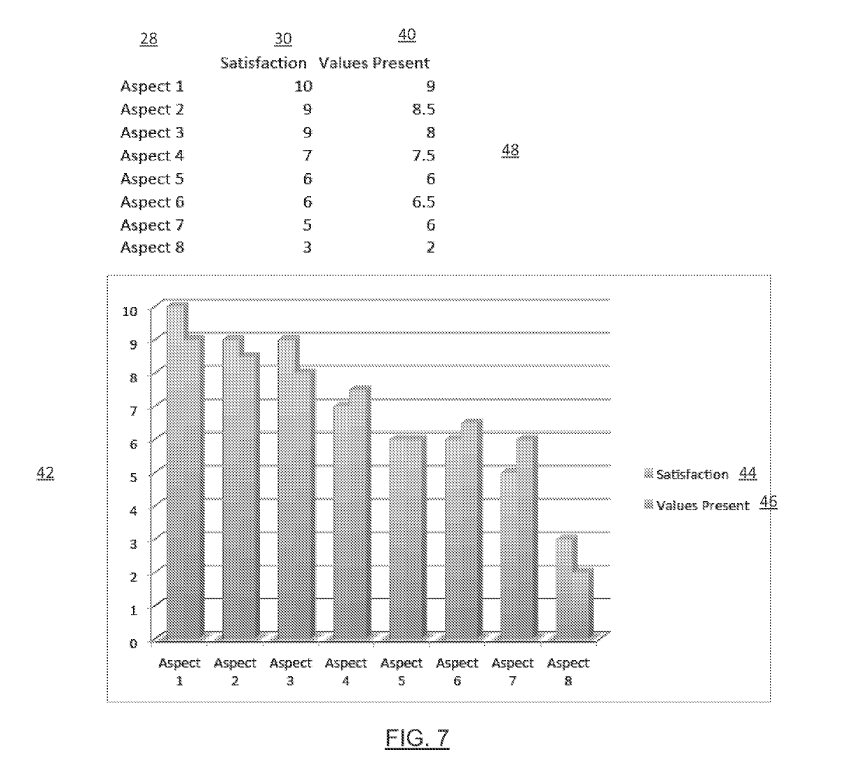

At step 405 (FIG. 3), Life Assessment Module 240 receives evaluation data for some or all life aspects. The evaluation data is stored in user data storage device 210 and user profile in relation to the corresponding life aspect. Evaluation data may provide an indication of a level of satisfaction, contentment, fulfillment, enjoyment or happiness for each life aspect. Evaluation data may also provide an indication of a level of dissatisfaction. Referring now to FIG. 6, there is shown evaluation data 20 (referred to as a level of satisfaction in this non-limiting illustrative example) for life aspects 18, including Personal Happiness, Career, Health, Significant Other, Friendships, Family, Recreation, and Finance. In this example, evaluation data 20 is provided on a scale of one to ten, when one corresponding to a low level of satisfaction for a given life aspect and ten corresponding to a high level of satisfaction for a given life aspect. Referring now to FIG. 7, there is also shown evaluation data 30 for corresponding life aspects 28. Life Assessment Module 240 is operable to receive updates to evaluation data as the level of satisfaction for a given life aspect may change over time. The updates may override existing evaluation data or may be added in addition to existing evaluation data as a different evaluation session. A level on a scale of one to ten is a non-limiting example and other types of evaluation data may be used to provide an indication of a level of satisfaction (or dissatisfaction) with aspects.

At step 410 (FIG. 3), Trigger Module 230 determines negative triggers. The negative triggers may be received as user input. A negative trigger may create negative reaction or emotion for the user. This may be a common negative reaction for the user, a projected future negative reaction, a past negative reaction, a newly occurring negative reaction, and the like. Negative triggers are things that may make a user mad, irate, furious, angry, frustrated, annoyed, irritated, sad, gloomy, blue, depressed, unhappy, low, miserable, hopeless, desperate, and the like. The negative triggers may be based on historical data (e.g. previous negative triggers for the user), user demographics (e.g. negative triggers for other users with corresponding demographics), or previous negative triggers from other users. Trigger Module 230 is operable to provide a suggested list of negative triggers for selection by user. The triggers may be stored in a local data storage device and/or user data storage device 210 and in association with user profile. The negative triggers may indicate or describe an action, person, place or thing that incites a negative emotion or reaction for the user. For example, being cut off in traffic, a messy house, kids misbehaving in public, a delayed airline flight, people being habitually late, someone taking credit for your work, may create a negative emotion for a user. Any number of negative triggers may be determined by Trigger Module 230. A user will be associated with a unique set of negative triggers, where the set of negative triggers may be stored as part of or in association with the user's profile. The set of negative triggers for a user may be associated with a unique identifier for use by Trigger Module 230 to identify that set of data as a set of negative triggers.

At step 415, Counter Module 235 further determines positive counters to the negative triggers. The positive counters may be a positive emotion that is opposite to or lacking in the negative trigger. A positive counter may counteract the negative reaction of the negative trigger. A positive counter may make the user happy, glad, laugh, content, joyful, blissful, cheerful, and the like. The positive counters may be received as user input. The positive counters may be based on historical data (e.g. previous positive counters to the same negative triggers), user demographics (e.g. positive counters for other users with corresponding demographics), or previous positive counters for other users. Counter Module 235 is operable to provide a suggested list of positive counters for selection by user, or receive positive counters as user input via a text form, and the like. The positive counters are then stored in a local data storage device and/or user data storage device 210 and in association with user profile. For example, a positive counter to a large debt may be financial security. As another example, a positive counter to being cut off in traffic may be patience or courtesy. A user will be associated with a unique set of positive counters, where the set of positive counters may be stored as part of or in association with the user's profile. A subset of positive counters may also be associated with the related negative trigger. The set of positive counters for a user may be associated with a unique identifier for use by Counter Module 235 to identify that set of data as a set of positive counters.

At step 420, Value Module 255 identifies personal values using the negative triggers and positive counters. A personal value may be a belief that influences an attitude or a behavior of the user. A personal value may be an ethical value, which can be the basis for ethical action. A personal value is a foundation upon which other values and measures of integrity are based. A value may be absolute or relative. The values may be an expression or an abstraction of one or more positive counters. The values may be received as user input. The values may be based on historical data (e.g. previous values for the positive counters or negative triggers), user demographics (e.g. values for other users with corresponding demographics), other personal values for other users, and so on. Trigger Module 230 is operable to provide a suggested list of values for selection by user. The values are stored in user data storage device 210 and in association with user profile. A user will be associated with a unique set of values, where the set of values may be stored as part of or in association with the user's profile. The set of values for a user may be associated with a unique identifier for use by Value Module 255 to identify that set of data as a set of positive counters.

Referring now to FIGS. 4, 5A and 5B there are shown exemplary values 12, 17 Faith, Hard Work, Integrity, Love, Self, Creation, Connection, Momentum, and so on. These are non-limiting examples only and other values or numbers of values may be identified. Values may be cultural and may be tied to a belief system of a user. Values may be broad preferences concerning appropriate courses of action or outcomes based on the positive counters. Personal values provide an internal reference for what is good, beneficial, important, useful, beautiful, desirable, constructive, and so on. Values may be associated with a priority score or rank. Input data may be used to generate a priority score to prioritize a person's values. For example, Value Module 255 may provide an interface guiding a user through prioritizing their top values in a one-through-five rank order approach. This is a non-limiting example of a ranking scheme and other scores or ranking mechanisms may be used to compare values relatives to other values.

Table 1 illustrates non-limiting examples of negative triggers, corresponding positive counters, and possible values.

TABLE 1

| Negative Trigger | Positive Counter | Possible Values |
|---|---|---|
| Being cut off in | Patience | Taking the ‘back seat’ |
| traffic | “He who is last shall be first.” | Respect |
| | Respect | Patience |
| | Courtesy | Service |
| | Manners | |
| | Being polite | |
| Being stuck in a | “‘Variety’ is the spice of life.” | Spice |
| rut | Exploration | Variety |
| | New experiences | Growth |
| | Learning | Horizons |
| | Growth | Robert Frost |
| | Poem: “The Road Not Taken” | Adventure |
| | Adventure | Christopher Columbus |
| My terrible boss | Song: “Take this job and shove it” | Achievement |
| | Support | Progress |
| | Mentoring | Momentum |
| | Teaching and Learning | Accomplishment |
| | Having someone's back | Jack Welch |
| A messy and | Order | Efficiency |
| cluttered house | Tidiness | Order |
| | Organization | Godliness |
| | “A place for everything and | |
| | everything in its place.” | |
| | Beauty | |
| | Pride | |
| | “Cleanliness is next to Godliness” | |
| Taking credit for | Honesty | Integrity |
| someone else's | Support | Honesty |
| work | Collaboration | Appreciation |
| | Cooperation | Team |
| | Respect | |
| | Trust | |
| Being sick or | “Early to bed. Early to rise. | Self |
| injured | Makes you healthy, wealthy, & wise.” | My Foundation |
| | Physical fitness | Body/Mind/Spirit |
| | Mental & emotional wellbeing | Wellbeing |
| | Having an active lifestyle | Wellness |
| | Song: “Let's get physical” | Olivia Newton John |
| Flight delays | Punctuality | Reliability |
| | Service | Respect |
| | Respect | Service |
| | Proper planning | Responsiveness |
| | Honoring commitments | |

At step 425, the user enters value assessment data for a combination of a value and a life aspect. The value assessment data may provide an indication of how present or existent the value is within a given life aspect. The value assessment data is then stored in user data storage device 210 and in association with user profile. Referring now to FIG. 5 there is shown an example of value assessment data provided as one of: fully present, strong, ok, weak, and not there. For example, a value assessment 19 of “weak” may be allocated for the life aspect 15 “finance” and the value “self”. A value assessment table 25 may store value assessment data for each life aspect/value combination.

Referring now to FIG. 4, there is shown other examples of value assessment data provided on a scale of one to five, where one may indicate that the value is not present within the life aspect and five may indicate that the value is fully present within the life aspect. A value assessment table 11 may store value assessment data for each life aspect/value combination. For each value/life aspect combination in the value assessment table, there is stored value assessment data representing how present the respective value is within the respective life aspect. That is, for each user, the value assessment data indicates how important or present a particular value is within a particular life aspect at a certain point in time. For example, for the combination of value “Hard Work” and life aspect “Career”, the exemplary value assessment table has a stored value assessment data of “5” on a scale of 1-5 (scale not shown). This indicates that the user feels very strongly about the importance or virtue of “Hard Work” in his or her Career, or that the user recognizes that he or she is a very hard working individual at work. The value assessment data of each value in each life aspect may be on any suitable scale. Similarly, FIGS. 5A and 5B indicate rankings of values on a numeric scale of one to five. This is an example only and other scoring or ranking mechanisms may be used to evaluate values.

At step 430, Life Assessment Module 240 is operable to generate value assessment results using the evaluation data for life aspects, value assessment data for combinations of value/life aspect, data in user profile (e.g. demographic data), and the like. The value assessment results may be stored in association with user profile.

For example, at step 435, Life Assessment Module 240 is operable to generate total value present scores 36 for the values (FIGS. 5A and 5B), which are examples of value assessment results. A total value present score 36 may be an average of the value assessment data for a particular life aspect. A total value present score 36 may provide an indication of how present the value is in all life aspects. Life Assessment Module 240 generates total life alignment scores 34 for life aspects (FIGS. 5A and 5B), which are examples of value assessment results. A total life alignment score 34 may be an average of the value assessment data for a particular value with respect to all or some of the life aspects. A total life alignment score 34 may provide an indication of how present a particular value is within some or all life aspects.

Life Assessment Module 240 is operable to suggest a list of life aspects based on historical data in a user profile, or based on a general list of common life aspects stored in a local data storage device. A user may enter as input his or her life aspects as he or she sees fit, or picking one or more life aspects from the suggested list of life aspects provided by Life Assessment Module 240. Therefore the plurality of life aspects for a value assessment table may include user-entered life aspects, life aspects based on historical data in a user profile and confirmed by the user, life aspects from the general list of common life aspects and chosen by the user, and so on. There may be a fixed set of life aspects for all users, or a subset of users. For example, all users of a particular office or division may use the same fixed set of life aspects. An administrative user for the organization may generate the fixed set of life aspects. There may also be a customized set of life aspects for a user or a set of users.

Life Assessment Module 240 is operable to store the evaluation data and value assessment data in a value assessment table in user data storage device 210 and generate a total value present score and a total life alignment score. There may also be a total score summarizing both the total value present score and the total life alignment score such as the 54%/OK shown in FIG. 5A.

Both evaluation data and value assessment data in a value assessment table are input data may be obtained from users. Once received by value assessment system 220, the evaluation data and value assessment date are stored in user storage device 210. The value assessment system 220 can then further generate total value present score for each value in the plurality of values using the value assessment data for the respective value. The total value present score generally indicates how present the respective value is within the plurality of life aspects in a value assessment table. Similarly, the value assessment system 220 can also generate total life alignment score using the value assessment data for the respective value. The total life alignment score generally indicates how present the plurality of values is within each respective life aspect in the plurality of life aspects. Specifically, the total value present score for a particular value can be the sum, average, or median of all the value assessment data of the particular value with respect to each life aspect in the plurality of life aspects. The total life alignment score for a particular life aspect can be the sum, average, or median of all the value assessment data of the plurality of values for the particular life aspect.

For example, the value assessment system 110 may be used by a corporation to measure the level of employee engagement and comparison results may be provided different levels of granularity, such as an individual, team, department, city, nation, global corporation, and the like. The results may indicate opportunities for improving employee engagement and making cultural change.

At step 450, Comparison Module 250 is operable to generate comparison data. Such comparison or benchmarking can be done across time intervals, user demographics, various data from a first value assessment table and a second value assessment table, and the like. Comparison module 250 is operable to generate comparison data including a comparison of results data for to a specific individual (e.g. comparing their current results against past results). Comparison module 250 is operable to generate benchmarking data including a comparison of results data for a specific individual to different individuals, or aggregated data for multiple individuals (e.g. average for a certain demographic range).

Referring to FIG. 6, there is shown an example of comparison data. The comparison data includes evaluation data 20 for life aspects compared to total value present scores 38 for life aspects. Generally, there may be a correlation between evaluation data 20 for a particular life aspect and a total value present score 38 for the life aspect, even though the two data sets are independently generated.

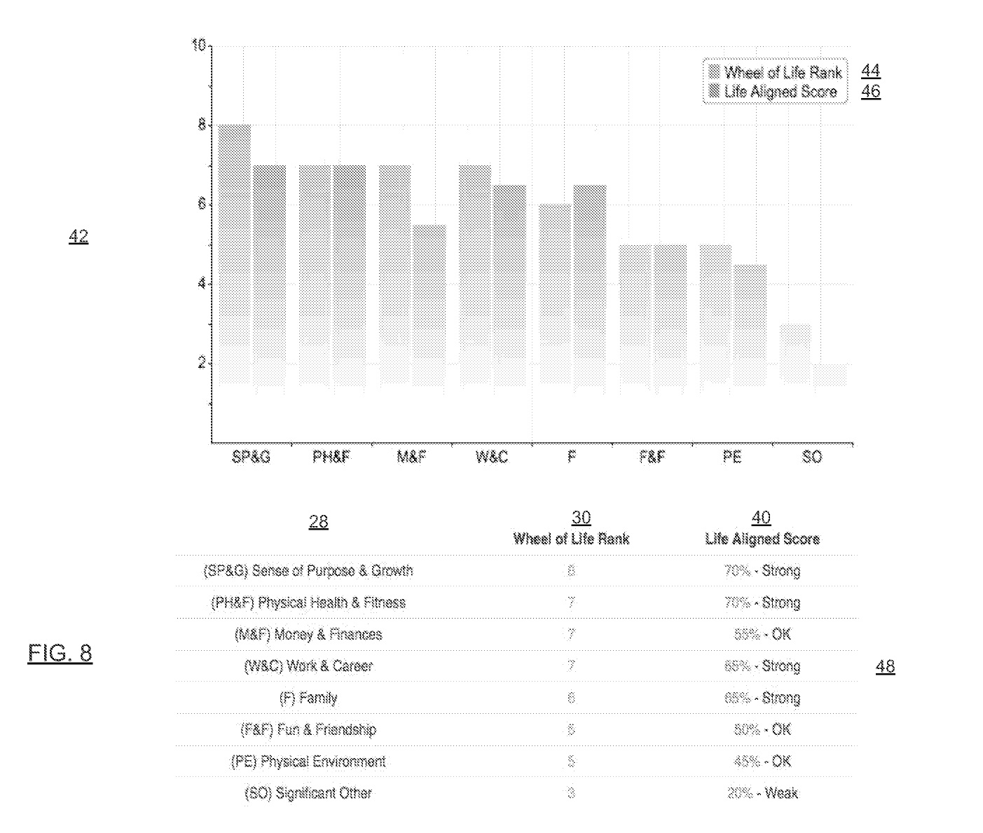

Referring to FIGS. 7 and 8, there is shown further examples of comparison data. The comparison data includes a bar graph 42 linking evaluation data 44 for life aspects to total value present scores 46 for life aspects. Again, there may be a correlation between evaluation data 44 for a particular life aspect and a total value present score 46 for the life aspect, even though the two data sets are independently generated. There is also shown a chart 48 comparing evaluation data 30 to total value present scores 40 for life aspects 28. These are examples only and other comparison data and visual renderings of comparison data may be used. For example, a mapping interface may be displayed illustrating total value present scores for each country or city. As another example, a timeline may be created for a user to compare results specific to the user over time, such as evaluation data, total value present scores, and the like. The comparison data may also compare one user to another user, or group of users to illustrate trends, historical statistics and the like.

Comparison Module 250 is operable to generate life aspect comparison results for each of the plurality of life aspects. The life aspect comparison may compare, for each of the plurality of life aspects, the evaluation data and the total life alignment score for the respective life aspect. That is, Comparison Module 250 is operable to determine a life aspect comparison value, for each of the plurality of life aspects, based on the evaluation data and the total alignment score for the respective life aspect in each of the plurality of life aspects. The life aspect comparison value may be determined by multiplying the evaluation data and the total life alignment score for the respective life aspect, or by using other mechanisms.

Comparison Module 250 is operable to, if requested, further compare value assessment data stored in a first value assessment table and a second value assessment table, with the second value assessment table being created after the first assessment table. Both tables may be associated with the same user profile. Comparison Module 250 may benchmark the value assessment data in the second value assessment table against those in the first value assessment table in order to give a user a clear picture of how his or her values have progressed or changed over time, thus demonstrating his or her personal growth (or lack thereof).

In a similar manner, Comparison Module 250 is operable to compare and benchmark the evaluation data in a first value assessment against that in a second value assessment table, with the second value assessment table being created after the first assessment table. Both tables may belong to the same user profile. Comparison Module 250 is operable to further compare and benchmark both the value assessment data and the evaluation data in a first value assessment against those in a second value assessment table, with the second value assessment table being created after the first assessment table.

Comparison Module 250 is operable to also compare and benchmark the total value present score (or the total life alignment score) in a second assessment table against the total value present score (or the total life alignment score) in a first assessment table. The first assessment table is created prior to the second assessment table, and both tables belong to the same user profile. Other example comparison results female-to-male comparison of happiness/satisfaction levels for all life aspect, or for a specific life aspect such as “Career”, top five values of men aged 30-45 in U.S. vs. Canada, top five negative triggers of women aged 45-55 in U.S. vs. Canada, and so on.

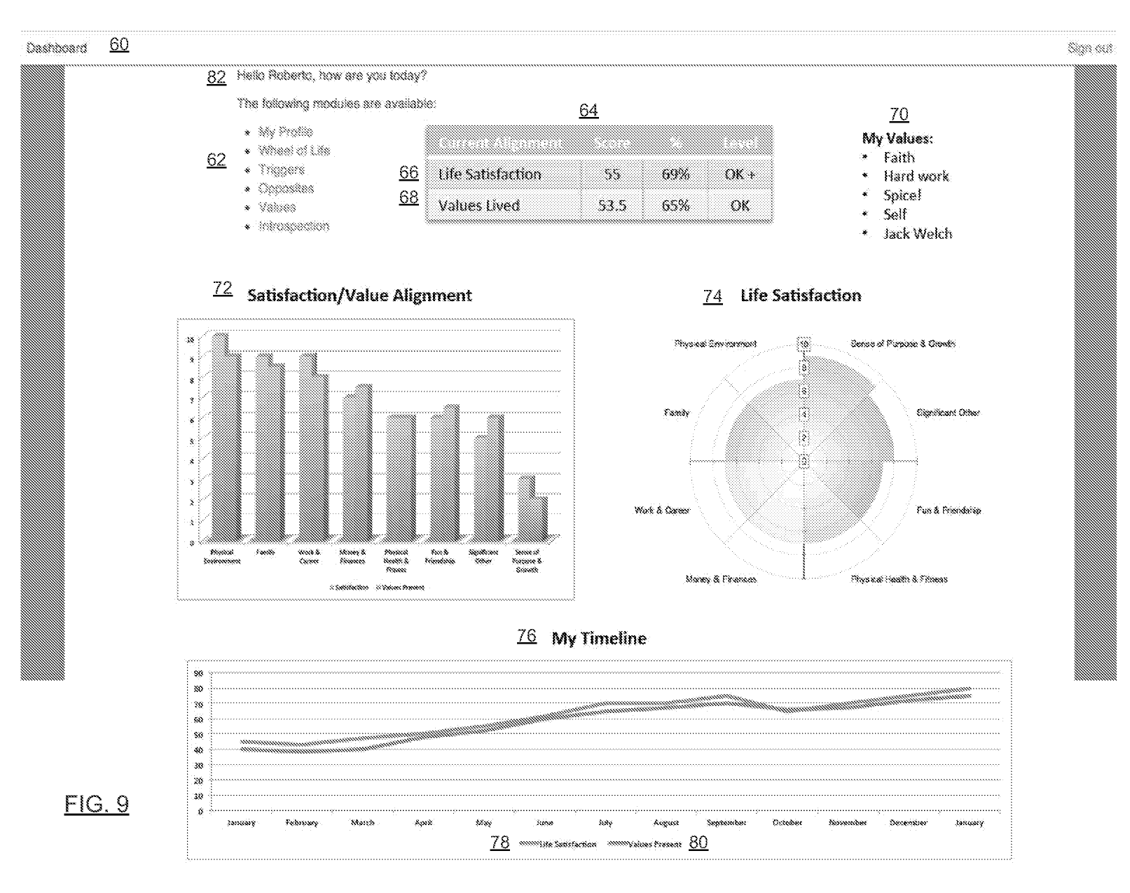

Referring now to FIG. 9 there is shown an example user interface 60 providing value assessment results accordingly to one or more embodiments. The user interface 60 may be referred to as a “dashboard” providing an interface to value assessment system 220. User interface module 245 (FIG. 2) is operable to generate a user interface 60 providing value assessment data to a user of value assessment system 220. User interface module 245 is operable to interact with other components of system 10 and modules of value assessment system 220 in order to generate and populate user interface 60. User interface module 245 is operable to dynamically update the user interface 60 based on updates to data managed by value assessment system 220.

The user interface 60 may display data from a user's profile 82 such as the user name. The user interface 60 may provide access links 62 to various modules such as a Profile Module to configure data in the user's profile (referred to in this illustrative example as “my profile”), Life Assessment Module 240 (referred to in this illustrative example as “wheel of life”), Trigger Module 230 (referred to in this illustrative example as “triggers”), Counter Module 235 (referred to in this illustrative example as “opposites”), Value Module 245 (referred to in this illustrative example as “values”), and Comparison Module 250 (referred to in this illustrative example as “introspection”).

The user interface 60 may provide a table 64 of value assessment results including total value present score 66 and a total life alignment score 68 which may include a numerical score, a percentage based score and a level.

The user interface 60 may provide a summary of values 70 for a user, such as faith, hard work, spice, self and Jack Welch, as a non-limiting illustrative example. A value is a belief, word, person, statement, and so on that influences an attitude or a behavior of the user.

The user interface 60 may provide a chart 72 of value assessment results. In this non-limiting illustrative example the chart 75 may include comparison results such as a comparison of evaluation data for life aspects to received value assessment data summarized for each life aspect. The chart 72 may include other types of comparison results.

The user interface 60 may provide a life satisfaction wheel 74 illustrating evaluation data for each life aspect, where the evaluation data may be provided on a scale of one to ten. One may be closest to the center of the life satisfaction wheel 74 and ten may be the closest to the perimeter of the life satisfaction wheel 74. A value of evaluation data for a life aspect may indicate a level of satisfaction for the respective life aspect.

The user interface 60 may also include a timeline 76 for the user depicting changes over time in value assessment results for evaluation data 78 for life aspects and value assessment data 80 summarized for each life aspect. The timeline 76 is another example of value assessment results or comparison results. This example timeline 76 illustrates a period of one year from January to January shown on one axis and results from 0 to 90 on another axis.

The user interface 60 of FIG. 9 is a non-limiting example and other configurations and value assessment results may be provided therein. One or more users 160a, 160b may operate a user device 140, 150 operable to display user interface 60, as well as send and receive data from value assessment system 120, 220. User device 140, 150 is operable by a user 160a, 160b and may be any portable, networked (wired or wireless) computing device including a processor and memory and suitable for facilitating communication between one or more computing applications of user device 140, 150 (e.g. a computing application installed on or running on the user device), the value assessment system 110, 220, and optionally, cloud services (not shown) to store personal data.

In accordance with some embodiments, user device may be a mobile computing device 140 or a desktop computing device 150. A mobile computing device may be a two-way communication device with advanced data communication capabilities having the capability to communicate with other computer systems and devices. The mobile device may include the capability for data communications and may also include the capability for voice communications. Depending on the functionality provided by the mobile device, mobile device may be referred to as a portable electronic device, smartphone, a data messaging device, a two-way pager, a cellular telephone with data messaging capabilities, personal digital assistant, a wireless Internet appliance, a portable laptop computer, a tablet computer, a media player, an electronic reading device, a data communication device (with or without telephony capabilities) or a combination of these. User device 140, 150 may be connected to value assessment system 120, 220 via any suitable communications channel. For example, the user device 140, 150 may communicate with the value assessment system 120, 220 over a Local Area Network (LAN) or intranet, or using an external network. User device may also have additional embedded components such as a global positioning system (GPS), a clock, a calendar, and so on. User device 140, 150 may also be connected to and receive data from other devices that collect data regarding the user, objects associated with the user, and so on.

User device 140, 150 may be configured with various computing applications, such as computing application particularly configured to interact with value assessment system 110, 220 and display user interface 60. A computing application may correspond to hardware and software modules comprising computer executable instructions to configure physical hardware to perform various functions and discernible results. A computing application may be a computer software or hardware application designed to help the user to perform specific functions, and may include an application plug-in, a widget, instant messaging application, mobile device application, e-mail application, online telephony application, java application, web page, or web object residing, executing, running or rendered on the user device 140, 150 specific to value assessment system 120, 220 and user interface 60. User device may access the functionality of server, by providing and receiving data and carrying out actions and instructions, for example. User device 140, 150 is operable to register and authenticate users (using a login, unique identifier, and password for example) prior to providing access to applications, value assessment system 120, 220, and user interface 60. User devices 140, 150 may be different types of devices and may serve one user or multiple users.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

1. A computer device for providing value assessments for a user, wherein the device comprises:
an electronic receiver coupled to:
a life assessment module for receiving a plurality of life aspects, wherein each life aspect categorizes an area of the user's life, and for receiving evaluation input data for each of a plurality of life aspects, wherein the evaluation input data indicates a level of satisfaction for the respective life aspect;
a trigger module for receiving a plurality of negative triggers, wherein each negative trigger may create negative reaction for the user; and
a counter module for, for each of the plurality of negative triggers, receiving a positive counter to the respective negative trigger, wherein each positive counter may counteract the negative reaction of the negative trigger;
a processor configured to generate:
a value module for identifying a plurality of values based on the positive counters to the plurality of negative triggers, wherein each value is a belief that influences an attitude or a behaviour of the user, and for, for each combination of a value of the plurality of values and a life aspect of the plurality of life aspects, receiving value assessment input data that indicates how present the respective value is within the respective life aspect; and
a comparison module for transforming the received value assessment input data into value assessment results;
a data storage device for persistently storing the plurality of life aspects, the plurality of negative triggers, the plurality of positive counters, the plurality of values; and
a transmitter for electronically transmitting the value assessment results to a client device coupled thereto via a network.

2. A computer implemented method for providing value assessments for a user, the method comprising:
receiving, at a computing device from an input device, a plurality of life aspects, wherein each life aspect categorizes an area of the user's life;
receiving, at the computing device from the input device, evaluation input data for each of a plurality of life aspects, wherein the evaluation input data indicates a level of satisfaction for the respective life aspect;
receiving, at the computing device from the input device a plurality of negative triggers, wherein each negative trigger may create a negative reaction for the user;
for each of the plurality of negative triggers, receiving, at the computing device from the input device, a positive counter to the respective negative trigger, wherein each positive counter may counteract the negative reaction of the negative trigger;
identifying, using a processor, a plurality of values based on the positive counters to the plurality of negative triggers, wherein each value is a belief that influences an attitude or a behaviour of the user, wherein the plurality of values are stored in a data storage device coupled to the processor;
for each combination of a value of the plurality of values and a life aspect of the plurality of life aspects, receiving, at the computing device from the input device, value assessment input data that indicates how present the respective value is within the respective life aspect;
transforming, using the processor, the received value assessment input data into value assessment results; and
transmitting, from the computing device to an output device, the value assessment results.

3. The method of claim 2, further comprising, for each of the plurality of values, generating, using the processor, a total value present score using the received value assessment input data for the respective value, wherein the total value score indicates how present the respective value is within the plurality of life aspects, and transmitting, from the computing device to the output device, the total value present score(s).

4. The method of claim 2, further comprising, for each of the plurality of life aspects, generating, using the processor, a total life alignment score using the received value assessment input data for the respective value, wherein the total life alignment score indicates how present the plurality of values is within the respective life aspect, and transmitting, from the computing device to the output device, the total life alignment score(s).

5. The method of claim 4, further comprising generating, using the processor, life aspect comparison results for each of the plurality of life aspects, wherein the life aspect comparison results compare, for each of the plurality of life aspects, the evaluation input data and the total life alignment score for the respective life aspect, and transmitting, from the computing device to the output device, the life aspect comparison results.

6. The method of claim 2, wherein the value assessment input data is received for a first time interval, and wherein the method further comprises:
receiving, at the computing device from the input device, additional value assessment input data for a second time interval; and
benchmarking, using the processor, the additional value assessment input data for the second time interval against the value assessment input data for the first time interval.

7. The method of claim 6, further comprising, for each of the plurality of values:
generating, using the processor, a first total value present score for the first time interval using the received value assessment input data for the first time interval for the respective value, wherein the first total value score indicates how present the respective value is within each of the plurality of life aspects;
generating, using the processor, at least a second total value present score for the second time interval using the received value assessment input data for the second time interval for the respective value, wherein the second total value score indicates how present the respective value is within each of the plurality of life aspects; and
benchmarking, using the processor, the second total value present score against the first total value present score.

8. The method of claim 6, further comprising, for each of the plurality of life aspects:
generating, using the processor, a first total life alignment score using the received value assessment input data for the first time interval for the respective value, wherein the total life alignment score indicates how present the plurality of values is within the respective life aspect;
generating, using the processor, a second total life alignment score using the received value assessment input data for the second time interval for the respective value, wherein the total life alignment score indicates how present the plurality of values is within the respective life aspect; and
benchmarking, using the processor, the second total life alignment score against the first total life alignment score.

9. The method of claim 2, wherein the value assessment input data and evaluation input data are received for a first time interval, and wherein the method further comprises:
receiving, using the processor, additional value assessment input data for a second time interval;
receiving, using the processor, additional evaluation input data for a second time interval;
benchmarking, using the processor, the additional value assessment input data for the second time interval against the value assessment input data for the first time interval; and
benchmarking, using the processor, the additional evaluation input data for the second time interval against the evaluation input data for the first time interval.

10. The method of claim 2, wherein the plurality of life aspects comprises one or more members of the group selected from personal happiness, career, health, significant other, friendships, family, recreation, and finance.

11. The method of claim 2, wherein the plurality of values are selected from the group consisting of faith, hard work, integrity, love, and self.

12. The method of claim 2, wherein the value assessment results are generated based on the received evaluation input data.

13. A computer interface for providing value assessments for a user, wherein the computer interface is provided using a processor and a memory coupled to the processor and configured to store instructions executable by the processor to:
receive, from an input module, a plurality of life aspects, wherein each life aspect categorizes an area of the user's life;
receive, from the input module, evaluation input data for each of a plurality of life aspects, wherein the evaluation input data indicates a level of satisfaction for the respective life aspect;
receive, from the input module, a plurality of negative triggers, wherein each negative trigger may create negative reaction for the user;
for each of the plurality of negative triggers, receive, from the input module, a positive counter to the respective negative trigger, wherein each positive counter may counteract the negative reaction of the negative trigger;
identify, using a processor, a plurality of values based on the positive counters to the plurality of negative triggers, wherein each value is a belief that influences an attitude or a behaviour of the user, wherein each value is stored in a data storage device;
for each combination of a value of the plurality of values and a life aspect of the plurality of life aspects, receive, from the input module, value assessment input data that indicates how present the respective value is within the respective life aspect; and
update a display screen coupled to the processor to provide value assessment results by transforming, using the processor, the received value assessment input data.

14. The computer interface of claim 13, where the processor is further configured to, for each of the plurality of values, update the display screen to provide a total value present score calculated using the received value assessment input data for the respective value, wherein the total value score indicates how present the respective value is within the plurality of life aspects.

15. The computer interface of claim 13, where the processor is further configured to, for each of the plurality of life aspects, update the display screen to provide a total life alignment score calculated using the received value assessment input data for the respective value, wherein the total life alignment score indicates how present the plurality of values is within the respective life aspect.

16. The computer interface of claim 13, where the processor is further configured to, update the display screen to provide life aspect comparison results for each of the plurality of life aspects, wherein the life aspect comparison results compare, for each of the plurality of life aspects, the evaluation input data and the total life alignment score for the respective life aspect.

17. The computer interface of claim 13, wherein the value assessment input data is received for a first time interval, and wherein the processor is further configured to:
receive, from the input module, additional value assessment input data for a second time interval; and
update the display screen to provide a benchmark of the additional value assessment input data for the second time interval against the value assessment input data for the first time interval.

18. The computer interface of claim 17, where the processor is further configured to, for each of the plurality of values:
generate a first total value present score for the first time interval using the received value assessment input data for the first time interval for the respective value, wherein the first total value score indicates how present the respective value is within each of the plurality of life aspects;
generate at least a second total value present score for the second time interval using the received value assessment input data for the second time interval for the respective value, wherein the second total value score indicates how present the respective value is within each of the plurality of life aspects; and
update the display screen to provide a benchmark the second total value present score against the first total value present score.

19. The computer interface of claim 17, where the processor is further configured to, for each of the plurality of life aspects:
generate a first total life alignment score using the received value assessment input data for the first time interval for the respective value, wherein the total life alignment score indicates how present the plurality of values is within the respective life aspect;
generate a second total life alignment score using the received value assessment input data for the second time interval for the respective value, wherein the total life alignment score indicates how present the plurality of values is within the respective life aspect; and
update the display screen to benchmark the second total life alignment score against the first total life alignment score.

20. The computer interface of claim 13, wherein the value assessment input data and evaluation input data are received for a first time interval, and where the processor is further configured to:
receive additional value assessment input data for a second time interval;
receive additional evaluation input data for a second time interval;
update the display to benchmark the additional value assessment input data for the second time interval against the value assessment input data for the first time interval; and
update the display to benchmark the additional evaluation input data for the second time interval against the evaluation input data for the first time interval.
